(19) United States
(12) Patent Application Publication
(10) Pub. No.: US 2004/0197150 A1
(43) Pub. Date: Oct. 7, 2004

(54) CHEMICAL OXIDATION OF ORGANIC AND INORGANIC CONTAMINANTS BY CHELATED TRANSITION METALS CATALYZED PERSULFATE

(75) Inventors: Clifford J. Bruell, N. Chelmsford, MA (US); Chenju Liang, N. Lowell, MA (US); Michael C. Marley, Newfields, NH (US); Kenneth L. Sperry, Newmarket, NH (US)

Correspondence Address: DECKER LAW OFFICE, 1 NEW HAMPSHIRE AVE., SUITE 125, PORTSMOUTH, NH, 03801, US

(73) Assignee: XPERT DESIGN AND DIAGNOSTICS, LLC, Stratham, NH (US)

(21) Appl. No.: 10/707,204

(22) Filed: Nov. 26, 2003

Related U.S. Application Data
(60) Provisional application No. 60/320,086, filed on Apr. 4, 2003.

(51) Int. Cl. B09C 1/08

(52) U.S. Cl. 405/128.5; 405/263

(57) ABSTRACT

A method of oxidizing organic and inorganic contaminants in soil, sludge, groundwater, and wastewater having the steps of providing an aqueous solution of persulfate anions, catalyzing them with chelated transition metals, thereby producing free radicals for oxidizing the contaminated material.

### BACKGROUND OF INVENTION

a. Field of the Invention

The invention relates to the in situ and ex situ oxidation of organic and inorganic compounds in soils and groundwater.

b. Description of the Related Art

Soil and groundwater can become contaminated by a variety of substances. The substances include, without limitation, volatile organic compounds, semi-volatile organic compounds, PCBs, oils, energetic compounds, manufactured gas plant wastes, wood preservative wastes, and other organic compounds. The contaminated soil and groundwater must be treated to make it safe. Some of the methods for treating contaminated soil and groundwater are discussed below.

A method that uses thermally activated persulfate oxidation in conjunction with an electro-osmosis system to heat and transport the persulfate anions into fine grained soils is disclosed in U.S. Pat. No. 5,976,348, which is not admitted to being prior art by its mention in this Background section. A method that does not require electro-osmosis or heat would be preferable.

Another method oxidizes VOCs by introducing one or both of a water soluble peroxygen compound, such as a persulfate, and a permanganate, into the soil either in situ or ex situ, and is disclosed by U.S. Pat. No. 6,019,548, which is not admitted to being prior art by its mention in this Background section. This method may also use iron catalysts that are not complexed or chelated. The use of uncomplexed iron is a relatively inefficient process that often results in incomplete contaminant oxidation.

Two other patents disclose the use of complexed iron catalysts within oxidation systems. The oxidant used is hydrogen peroxide, and the process results in the production of hydroxyl radicals. The two patents are U.S. Pat. Nos. 5,741,427, and 6,319,328, which are not admitted to being prior art by their mention in this Background section. Hydrogen peroxide is not particularly persistent in contaminated soils, because it dissociates quickly. It is also hazardous and difficult to handle, compared to other materials.

Because of the limitations of the art before the present invention, there is a need for a method of oxidizing organic contaminants in soil, sludge, groundwater, and wastewater that does not require electro-osmosis, heat, or inefficient metal catalysts, and uses materials that are easy to handle and persistent in the contaminated material.

### SUMMARY OF INVENTION

An invention that satisfies the need for a method of oxidizing organic contaminants in soil, sludge, groundwater and wastewater that does not require electro-osmosis, heat, or inefficient metal catalysts, and uses materials that are easy to handle and persistent in contaminated material includes the steps of providing an aqueous solution of peroxygen anions, catalyzing them with chelated transition metals, thereby producing free radicals for oxidizing the contaminated material. These and other features, aspects, and advantages of the present invention will become better understood with regard to the following description, claims, and accompanying drawing.

### BRIEF DESCRIPTION OF DRAWINGS

FIG. 1 is a flow chart showing the process of the present invention.

### DETAILED DESCRIPTION

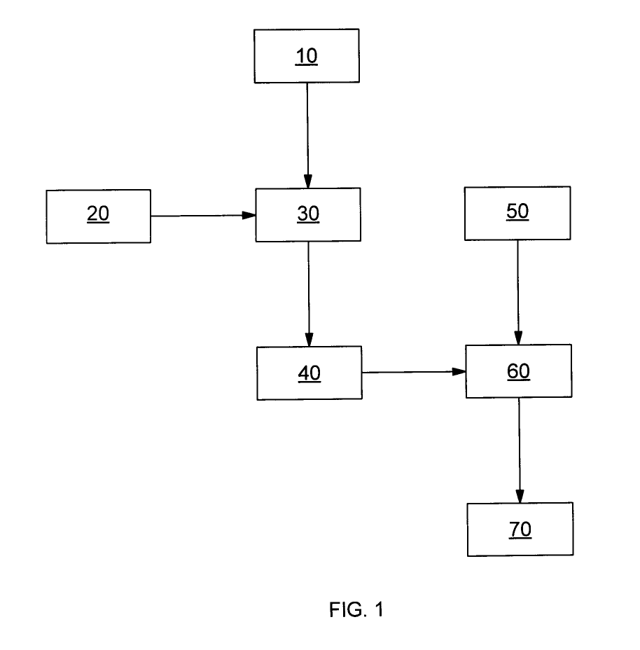

Turning to FIG. 1, this invention uses aqueous solutions of peroxygen anions 10 that are catalyzed 30 by chelated transition metals 20 to produce free radicals 40 that serve as powerful oxidants for the oxidation 60, and therefore destruction, of a large range of organic and inorganic compounds 50 to produce less-hazardous or non-hazardous, e.g., innocuous, reaction products 70. This method can be used for the destruction of organic contaminants either within soil or groundwater systems (in situ), or within reactor vessels (ex situ). The same method can also be used for controlling and oxidizing vapors and odors caused by excavating contaminated soil, sludge, groundwater, and wastewater.

Typical organic compounds 50 include, but are not limited to, volatile organic compounds (VOCs) (e.g., aliphatic and aromatic petroleum hydrocarbons, chlorinated solvents), semi-volatile organic compounds (SVOCs) (e.g., polycyclic aromatic hydrocarbons (PAHs)), polychlorinated biphenyls (PCBs), oils, energetic compounds (e.g., TNT, RDX, HMX), manufactured gas plant (MGP) wastes (e.g., coal tar), wood preserving wastes (e.g., chlorophenols), cations and anions (e.g. arsenite and ammonium ions). The preferred aqueous solution of peroxygen anions 10 is prepared from sodium persulfate, but could also be ammonium or potassium persulfate. The preferred chelated transition metal is a chelated iron (II) or (III) compound. The transition metal can also be ferrous iron, ferric iron, or ferrous sulfate. It preferably occurs naturally in the soil, sludge, groundwater, or wastewater to be treated. Typical chelating agents include, but are not limited to, citric acid, STPP, EDTA, oxalic acid, HEDPA, NTA, and hydroxyethyliminodiacetic acid (HEIDA).

The natural soil organic matter and reduced metals and minerals (e.g. iron and manganese oxides) will likely produce a soil oxidant demand (“SOD”). The SOD competes with the target compounds for oxidant like peroxygen. The user of the present method can supply extra peroxygen to take the SOD into account and assure complete oxidation of the target compounds.

The chelating agent 20 and peroxygen compound 10 can be added at ambient temperature, which is suitable for in situ applications. However, the peroxygen compound is more effective at higher temperatures in the range of 40 to 100° C.

Peroxygen 10 can be added first, and then the chelating agent or chelating agent/transition metal mixture 20, or the other way around. The chelating agent or chelating agent/transition metal mixture 20 could also be added first, and then peroxygen 10. Another method of adding or introducing the materials is by alternately adding them. That is to say, a volume of one substance is added first, then a volume of the second substance, followed again by a volume of the first substance, and so on. Depending on the application, a particular sequence of adding the materials will work the best.

The chemistry of peroxygen oxidation follows. Using persulfate as one example of a peroxygen, the persulfate anion (S₂O₈²⁻) is a strong two-electron oxidizing agent with a redox potential of 2.01 V. Reduction of the persulfate anion results in the production of sulfate anions as follows:

S₂O₈²⁻+2e⁻→2SO₄²⁻E°=2.01V

If sufficient quantities of a transition metal ion [e.g., ferrous iron (Fe²⁺)] are present serving as an electron donor, persulfate anions can also be catalytically decomposed to form the sulfate free radical (SO₄⁻•) 40 at ambient temperature. The stoichiometric reaction between persulfate and ferrous iron (Fe²⁺) is shown in the following equations:

2Fe²⁺S₂O₈²⁻→2Fe³⁺2SO₄²⁻ (i)

Through the steps:

Fe²⁺S₂O₈²⁻→Fe³⁺SO₄⁻•+SO₄²⁻ (ii)

SO₄⁻•+Fe²⁺→Fe³⁺+SO₄²⁻ (iii)

The sulfate free radical (SO₄⁻•) produced through step (ii) is a very powerful oxidant with a standard redox potential of 2.6 V, and is an even more aggressive oxidizing agent than the persulfate anion (S₂O₈²⁻) with a standard redox potential of 2.01 V. The sulfate free radical (SO₄⁻•) accepts a single electron resulting in the production of sulfate anions as:

SO₄⁻•+e⁻→SO₄²⁻E°≈2.6V

It is postulated that the sulfate free radical (SO₄⁻•) could be effective for the destruction of a wide range of organic compounds 50.

Other than iron, the general catalysts found in the art include the ions of copper, silver, manganese, cerium, and cobalt. Iron is a natural constituent of soils and one of the most abundant elements in minerals. In a soil water medium, iron is present in two different ionic forms, the dominant specie Fe²⁺ in anaerobic conditions and Fe³⁺ in aerobic conditions. For the application of the transition metal catalyzed persulfate oxidation process in the field, ferrous iron is a preferred catalyst.

The persulfate-ferrous iron reaction greatly facilitates the rapid production of sulfate free radicals. A half-life of 4 seconds has been reported at a persulfate and ferrous iron concentration of 10⁻³ mole L⁻¹ and a temperature of 40° C. The sulfate free radical converts ferrous iron to ferric iron through equation (iii). The reaction coefficient for equation (iii), at a diffusion-controlled rate, has been reported to be 1×10⁹ L mole⁻¹ sec. Therefore, the fast production of SO₄⁻• and fast reaction between SO₄⁻• and Fe²⁺ could possibly result in a sink for SO₄⁻• as well as lowering mineralization efficiency of organic compounds. In order to optimize the iron catalyzed persulfate oxidation, it is considered necessary to either reduce the competition for SO₄⁻• or increase the SO₄⁻• attack on the organic substance. This can presumably be achieved by slowing or delaying the formation of SO₄⁻•. In the other words, this process could possibly be accomplished by gradually providing adequate Fe²⁺ catalyst or preventing the quick conversion of Fe²⁺ to Fe³⁺ based on the chemistry of equation (ii) and (iii).

In some situations, it is advantageous to select a transition metal chelate to provide for the slow release of ferrous or ferric iron into solution and the prolonged formation of free radicals and transient oxygen species such that at least some of the peroxygen compound remains for at least thirty days after being introduced. This is very beneficial for in situ applications. Slowing the process in this way also improves efficiency of use of peroxygen to oxidize target contaminants.

The transition metal chelate and peroxygen compound system can also be selected to induce the continuous cycling of iron between the ferrous and ferric states with co-production of free radicals and transient oxygen species until the supply of the peroxygen compound is exhausted. Ferrous iron typically catalyzes the reaction to form the free radicals. Some of the radicals oxidize the ferrous iron to ferric iron. The chelate, however, can scavenge the ferric iron and reduce it back to ferrous to be utilized again in the reaction process.

Fenton's reaction is a similar system that uses iron catalyzed hydrogen peroxide to from hydroxyl radicals for the destruction of organics. Researchers have also used iron chelates as a catalyst in Fenton's reaction to control the rate of formation of reactive hydroxyl radicals, therefore, enhancing the reagent efficiency. A complexing agent that combines by coordinate bonding with metals may serve to reduce undesirable effects of metal ions as in sequestration, and to create desirable effects as in metal buffering and solubilization. Therefore, this obstacle of maintaining available ferrous iron in solution can be overcome by employing complexing agents (a.k.a. chelating agents) in conjunction with satisfactory Fe²⁺ content.

Under certain low-buffered systems, the persulfate reactions can create a low pH condition. If this occurs, a buffer can be added to adjust the pH to a relatively neutral range of 6 to 8.

When an organic compound is present in a non-aqueous phase liquid, the rate of dissolution to the aqueous phase may be increased due to co-solvency effects of the reaction byproducts. In other words, some of the intermediate compounds that form during the oxidation process are solvents themselves, and therefore improve the dissolution of the contaminants. They are more soluble in the solvent than in water. Therefore, this improves the oxidation process overall.

Biological degradation of organics can be facilitated by providing an electron donor or electron acceptor. The electron donor or acceptor is for stimulating the growth of indigenous microorganisms known to degrade organic compounds into innocuous end products. The electron donor could be either a) an organic compound that has been desorbed from the soil, and is therefore more bioavailable, b) a bioavailable form of partially degraded or oxidized organic contaminant, c) partially degraded natural organic carbon, d) an un-reacted chelating agent, or e) a byproduct of a reacted chelating agent. The electron acceptor could be either sulfate or oxygen where the indigenous microorganisms stimulated are sulfate-reducing bacteria or aerobic heterotrophic bacteria respectively.

The indigenous microorganisms can degrade the organic compounds into innocuous end products through metabolic, co-metabolic, or reductive processes. One example of such a process is dechlorination.

While there have been described what are at present considered to be the preferred embodiments of this invention, it will be obvious to those skilled in the art that various changes and modifications may be made therein without departing from the invention, and it is, therefore, aimed to cover all such changes and modifications as fall within the true spirit and scope of the invention.

1. A reagent for use in oxidizing organic and inorganic compounds either in soil, sludge, groundwater, or wastewater comprising a reaction product produced by the process comprising the steps of:
a. Preparing a solid phase water soluble transition metal chelate; and
b. Combining said solid phase water-soluble transition metal chelate with a solid phase water-soluble peroxygen compound.

2. A method for oxidizing organic and inorganic compounds either in soil, sludge, groundwater, or wastewater comprising the steps of:
a. Introducing a chelating agent or chelating agent/transition metal mixture in soil, sludge, groundwater, or wastewater to create a transition metal chelate in said soil, sludge, groundwater, or wastewater;
b. Introducing a solid phase water-soluble peroxygen compound to said soil, sludge, groundwater, or wastewater;
c. Using said transition metal chelate to catalytically decompose the peroxygen compound to produce free radicals and other transient oxygen species; and
d. Oxidizing organic and inorganic compounds either in said soil, sludge, groundwater, or wastewater by the peroxygen compound or the free radical or transient oxygen species formed.

3. The method as in claim 2, wherein the oxidization of organic and inorganic compounds in said soil, sludge, groundwater, or wastewater is performed in situ.

4. The method as in claim 2, wherein the oxidization of organic and inorganic compounds in said soil, sludge, groundwater, or wastewater is performed ex situ.

5. The method as in claim 2, wherein the organic and inorganic compounds are at least one taken from the group consisting of volatile organic compounds, fuel oxygenates and associated degradation intermediates, semi-volatile organic compounds, polychlorinated biphenyls, oils, energetic compounds, manufactured gas plant wastes, wood preserving wastes, cations and anions.

6. The method as in claim 2, wherein the transition metal is at least one of ferrous iron, ferric iron, and ferrous sulfate.

7. The method as in claim 2, wherein the transition metal is added to the soil, sludge, groundwater, or wastewater.

8. The method as in claim 2, wherein the transition metal selected is at least one that is naturally occurring in the soil, sludge, groundwater, or wastewater to be treated.

9. The method as in claim 8, wherein the naturally occurring transition metal is at least one taken from the group consisting of a soluble form of ferrous or ferric iron, an amorphous form of ferrous or ferric iron, and a solid form of ferrous or ferric iron.

10. The method as in claim 2, wherein the chelating agent is at least one taken from the group consisting of citric acid, STPP, EDTA, oxalic acid, HEDPA, NTA and hydroxyethyliminodiacetic acid.

11. The method as in claim 2, wherein the peroxygen compound is a persulfate.

12. The method as in claim 10, wherein the persulfate is at least one taken from the group consisting of a sodium base, ammonia base, and potassium base.

13. A method for oxidizing organic and inorganic compounds either in soil, sludge, groundwater, or wastewater comprising the steps of adding a chelating agent followed by adding a solid phase peroxygen compound.

14. The method as in claim 13, wherein the peroxygen compound is added first followed by adding the chelating agent.

15. The method as in claim 13, wherein the chelating agent and the peroxygen compound are added simultaneously.

16. The method as in claim 13, wherein the chelating agent and the peroxygen compound are alternately added.

17. The method as in claim 2, wherein the chelating agent is first mixed with the transition metal and added to the soil, sludge, groundwater, or wastewater followed by addition of the peroxygen compound.

18. The method as in claim 17, wherein the peroxygen compound is added first followed by addition of the chelating agent/transition metal mixture.

19. The method as in claim 17, wherein the chelating agent/transition metal mixture and the peroxygen compound are added simultaneously.

20. The method as in claim 17, wherein the chelating agent/transition metal mixture and the peroxygen compound are alternately added.

21. The method as in claim 2, wherein the said transition metal chelate is selected to provide for the slow release of ferrous or ferric iron into solution and the prolonged formation of free radicals and transient oxygen species such that at least some of the peroxygen compound remains for at least thirty days after being introduced.

22. The method as in claim 6, wherein the transition metal chelate and peroxygen compound system induces continuous cycling of iron between the ferrous and ferric states with co-production of free radicals and transient oxygen species until the supply of the peroxygen compound is exhausted.

23. The method as in claim 2, wherein the chelating agent, transition metal, and peroxygen compound are added as an aqueous solution.

24. The method as in claim 2, wherein the chelating agent, transition metal, and peroxygen are added as a solid phase water soluble compound.

25. The method as in claim 2, wherein the introducing steps are performed at ambient air, soil, sludge, groundwater or wastewater temperature.

26. The method as in claim 2, wherein the introducing steps are performed at temperatures between 40° C. and 100° C.

27. The method as in claim 2, further comprising the step of adjusting the acidity of the soil, sludge, groundwater, or wastewater prior to adding the chelating agent, transition metal, or peroxygen compound to a pH between 6 and 8.

28. The method as in claim 2, further comprising the step of adjusting the acidity of the soil, sludge, groundwater, or wastewater after adding the chelating agent, transition metal, or peroxygen compound to a pH between 6 and 8.

29. The method as in claim 2, wherein soil, sludge, groundwater, or wastewater has a soil oxidant demand, and the peroxygen compound at least partially satisfies the soil oxidant demand.

30. A method to increase the mass transfer of organic compounds to groundwater, wastewater or the water phase of soil and sludge comprising the steps:
a. Introducing a chelating agent or chelating agent/transition metal mixture in soil, sludge, groundwater or wastewater to create a transition metal chelate in said soil, sludge, groundwater, or wastewater;
b. Introducing a solid phase water-soluble peroxygen compound to said soil, sludge, groundwater, or wastewater;
c. Using said transition metal chelate to catalytically decompose the peroxygen compound to produce free radicals and other transient oxygen species; and
d. Oxidizing said organic and inorganic compounds in said soil, sludge, groundwater, or wastewater by the peroxygen compound or the free radical or other transient oxygen species formed.

31. The method as in claim 30, wherein the organic compound is present as a non-aqueous phase liquid and the rate of dissolution to the aqueous phase is increased due to co-solvency effects of reaction by-products.

32. The method as in claim 30, wherein the oxidation of organic compounds in the aqueous phase increases the rate of organic contaminant desorption from soil into the aqueous phase.

33. The method as in claim 30, wherein the peroxygen compound directly attacks and breaks down natural organic compounds that are present in soil, sludge, groundwater, or wastewater thereby liberating the organic compounds previously sorbed to the natural organic matter to the aqueous phase.

34. A method to enhance the biological degradation of organic compounds in soil, sludge, groundwater, or wastewater comprising the steps of:
a. Introducing a chelating agent or chelating agent/transition metal mixture in soil, sludge, groundwater, or wastewater to create a transition metal chelate in said soil, sludge, groundwater, or wastewater;
b. Introducing a solid phase water-soluble peroxygen compound to said soil, sludge, groundwater, or wastewater;
c. Using said transition metal chelate to catalytically decompose the peroxygen compound to produce free radicals and other transient oxygen species; and
d. Oxidizing said organic compounds either in soil, sludge, groundwater, or wastewater by the peroxygen compound or the free radical or transient oxygen species formed.

35. The method as in claim 34, wherein an electron donor is provided for stimulating the growth of indigenous microorganisms known to degrade organic compounds to innocuous end products.

36. The method as in claim 35, wherein the electron donor is the organic compound which has been desorbed from soil and hence is more bioavailable.

37. The method as in claim 35, wherein the electron donor is a bioavailable form of partially degraded or oxidized organic contaminant or partially degraded natural organic carbon.

38. The method as in claim 35, wherein the electron donor is an un-reacted chelating agent.

39. The method as in claim 35, wherein the electron donor is a byproduct of a reacted chelating agent.

40. The method as in claim 35, wherein the indigenous microorganisms degrade the organic compounds to innocuous end products through metabolic, co-metabolic, or reductive processes.

41. The method as in claim 40, wherein said process is dechlorination.

42. The method as in claim 34, wherein an electron acceptor is provided for stimulating the growth of indigenous microorganisms known to degrade organic compounds to innocuous end products.

43. The method as in claim 42, wherein the electron acceptor is sulfate and the class of indigenous microorganisms stimulate are sulfate-reducing bacteria.

44. The method as in claim 42, wherein the electron acceptor is oxygen and the class of indigenous microorganisms stimulated is aerobic heterotrophic bacteria.

45. A method for oxidizing vapors and odors arising from the excavation of contaminated soil, sludge, groundwater or wastewater comprising the steps of:
a. Introducing a chelating agent or chelating agent/transition metal mixture in contaminated soil, sludge, groundwater, or wastewater to create a transition metal chelate in said soil, sludge, groundwater, or wastewater;
b. Introducing a solid phase water-soluble peroxygen compound to said soil, sludge, groundwater, or wastewater;
c. Using said transition metal chelate to catalytically decompose the peroxygen compound to produce free radicals and other transient oxygen species; and
d. Oxidizing said organic compounds either in soil, sludge, groundwater, or wastewater by the peroxygen compound or the free radical or transient oxygen species formed.
